(19) United States
(12) Patent Application Publication
(10) Pub. No.: US 2014/0319895 A1
(43) Pub. Date: Oct. 30, 2014

(54) Device and Method for Adjusting a Seat Position

(71) Applicant: JOHNSON CONTROLS GMBH, Burscheid (DE)

(72) Inventors: Wei Lange-Mao, Hagen (DE); Andreas Eppinger, Bergisch Gladbach (DE)

(73) Assignee: Johnson Controls GMBH, Burscheid (DE)

(21) Appl. No.: 14/359,665

(22) PCT Filed: Nov. 6, 2012
(86) PCT No.: PCT/EP2012/071926

§ 371 Date: May 21, 2014

(30) Foreign Application Priority Data
Nov. 23, 2011 (DE) 10 2011 119 186.4
May 23, 2012 (DE) 10 2012 208 644.7

(51) Int. Cl. B60N 2/02; B60N 2/00

(52) U.S. Cl. CPC B60N 2/0224; B60N 2/002
USPC 297/463.1

(57) ABSTRACT

A device for adjusting a seat position of a vehicle seat allows for an automatic or automated adjustment of the seat position of the relevant vehicle seat. The device includes at least one vehicle seat, at least one first sensor unit for determining physical parameters of a potential vehicle passenger located outside of the vehicle and/or at least one input device and/or at least one second sensor unit for determining the scat position of the vehicle seat, and at least one control unit. A method is provided for the automatic or automated adjustment of a seat position of a vehicle seat by a device.

The invention relates to a device for adjusting a seat position for a vehicle seat according to the preamble of claim 1. Furthermore, the invention relates to a method for adjusting a seat position for a vehicle seat according to the preamble of claim 8.

The prior art discloses vehicle seats which have, in particular, electric drive units by means of which a seat position can be changed into numerous variations. In this context, a vehicle occupant operates a control device of the drive unit in order to set the seat position and, in particular, to change longitudinal displacement of a sitting surface in a vehicle, a sitting height, a sitting surface inclination, a backrest inclination and/or a position of a headrest of the vehicle seat.

Furthermore, electrically adjustable vehicle seats which have a memory unit are known. Position parameters which characterize a previously set seat position can be stored and retrieved by means of the memory unit. This relieves the vehicle occupant of the need to perform repeated and often awkward setting of the desired seat position. In particular, when the vehicle is used regularly by a plurality of persons this can save time.

DE 10 2005 020 847 describes a device and a method for contactless detection of biometric features and vital functions of passengers in a motor vehicle, in particular the heart rate and the breathing activities. These features and the spatial position of significant body parts in the interior of the passenger's bodies are used to control various comfort systems and safety systems in the vehicle such as, for example, fatigue detection system, identification/personalization, out-of-position detection (airbag control), seat occupation detection (airbag control), vehicle occupant classification (airbag control), automatic headrest setting, medical heart monitoring system, and anti-theft warning system.

Taking this prior art as the basis, the object of the present invention is to specify a device which is improved compared to the prior art and to specify an improved method for adjusting a seat position in a vehicle which facilitates or automates adjustment of a vehicle seat and which thus increases safety, comfort and/or the feeling of wellbeing of a vehicle occupant and, in particular, of the vehicle driver.

With respect to the device for adjusting a seat position for a vehicle seat, the object is achieved by means of the features specified in claim 1.

With respect to the method for adjusting a seat position for a vehicle seat, the object is achieved by means of the features specified in claim 8.

Advantageous developments of the invention are the subject matter of the dependent claims.

The device for the automatic or automated adjustment of a seat position for a vehicle seat permits automatic or automated adjustment of the seat position of the respective vehicle seat, wherein the device comprises at least one vehicle seat, at least one drive unit for adjusting the seat position of the vehicle seat, at least a first sensor unit for determining physical parameters of a potential vehicle occupant located outside the vehicle and/or at least one input means and/or at least one second sensor unit for determining the seat position of the vehicle seat and at least one control unit.

The device for adjusting the seat position permits automatic setting and/or pre-setting of the seat position to physical parameters of the vehicle driver and/or of the vehicle occupant. In this context, the automatic setting or pre-setting of the seat position is adapted to objectively determined physical parameters. This ensures the safety of the vehicle driver or of the vehicle occupant since individual errors during, in particular, manual adjustment of the seat position can be avoided.

In this context, automatic adjustment of the seat position is understood to mean a completely automatically occurring setting process of the vehicle seat for adapting the seat position.

Automated adjustment of the seat position is understood to mean a setting process of the vehicle seat which the occupant of the seat influences manually, at least in certain parts. Such manual influencing can occur, for example, as a manual operator control process of the electric drive unit for setting the seat position of the vehicle seat.

In an alternative embodiment variant, setting recommendations, generated on the basis of the physical parameters of the vehicle occupant and adapted thereto, for manually adjusting the seat position and/or warnings in the case of an unadjusted seat position are displayed to the vehicle occupant by means of a display unit.

One of the sensor units is preferably embodied as a bionic sensor, pressure sensor, force sensor, infrared sensor, laser sensor and/or ultrasonic sensor, and/or a further sensor unit of the sensor units is embodied as an optical detection unit.

In one embodiment variant, the optical detection unit is embodied as a conventional two-dimensional camera system, for example as an infrared camera, CCD camera or optical camera. In order to detect depth information and/or distance information of a detected object it is necessary to combine the two-dimensional camera system with a conventional distance sensor or what is referred to as a calibration object is used, i.e. an object in the detection range of the two-dimensional camera system with known dimensions, for example a vehicle component.

In a further embodiment variant, the detection unit is embodied as a conventional three-dimensional camera system, for example as a time-of-flight (TOF) camera and/or laser scanner and/or stereo camera. Distance information of a detected object can be measured directly by means of such a three-dimensional camera system.

In this context, a sensor unit is preferably embodied as a textile or polymeric capacitive or resistive sensor in a seat covering of the vehicle seat. By means of such a sensor which is integrated into a seat covering it is possible to detect vital parameters of the vehicle occupant, for example a heart rate, a pulse and/or an electrocardiogram.

A further sensor unit is preferably embodied as a force sensor or pressure sensor and is arranged or integrated in or on a seat covering and/or in an upholstered seat element. Pressure distribution over a surface of the vehicle seat can be detected by means of such a sensor which is integrated into or onto a seat covering and/or into an upholstered seat element.

A further sensor unit is preferably embodied as an optical detection unit, preferably as a laser scanner and/or as what is referred to as a time-of-flight (TOF) camera and/or stereo camera.

What is referred to as a time-of-flight (TOF) camera comprises a lighting unit, at least one optical element, at least one optical sensor and corresponding electronics for actuation and evaluation.

The principle of the TOF camera is based on a transit time method for distance measurement. For this purpose, for example, a passenger compartment of a vehicle or part of the passenger compartment of a vehicle is illuminated by means of a light pulse generated by the lighting unit, in particular the laser diode, wherein the TOF camera measures for each pixel the time which the light requires to travel to the object and back again to the optical sensor. The required time is preferably proportional to the corresponding distance. The detected scene, in particular the detected operator control process, is imaged on the optical sensor and subsequently correspondingly evaluated. The TOF camera here is very robust, adaptable and does not require any calibration.

The at least one optical sensor is particularly preferably embodied here as a photomix detector. The optical sensor can detect light in an infrared range. The optical sensor here is preferably integrated into the TOF camera or coupled thereto. For example, the optical sensor can be arranged in the overhead console of a vehicle. Alternatively, the optical sensor can also be oriented in the direction of the driver in a passenger compartment console or can be arranged in the instrument panel or in a headrest of a vehicle.

A further sensor unit can be embodied as a conventional mobile communication means, for example as a portable telephone, in particular as what is referred to as a smart phone or as a portable computer unit or as a games console and can transmit user-specific data to a control unit of the device according to the invention.

The sensor units carried along by the potential vehicle occupant or vehicle driver or are arranged inside and/or outside the vehicle and are for example inserted or integrated into corresponding items of clothing.

The potential vehicle occupant or vehicle driver who approaches a vehicle can be detected by the first sensor unit, which is embodied, for example, as a camera or laser scanner, wherein physical parameters of the vehicle occupant or vehicle driver, which characterize, in particular, a body size, an upper body length and the length of extremities such as legs and arms, can be determined on the basis of the detected data. By means of the physical parameters which are determined in this way it is possible to set automatically the seat position of the vehicle sent, which comprises, in particular, longitudinal displacement of the vehicle seat and/or vertical setting and orientation of a headrest, by actuating the drive unit of the vehicle seat. This avoids adjustment of the seat position which is time-consuming and susceptible to errors, and avoid, in particular, manual adjustment of the seat position.

In one alternative embodiment, a vehicle occupant can input his physical parameters manually, for example by means of corresponding input means in the vehicle, for example a conventional touch-sensitive screen and/or corresponding operator control elements, or by means of the mobile communication means, and the seat position is adapted by the control unit on the basis of this data.

According to one preferred embodiment of the invention, the first and/or second sensor units each comprise a plurality of sensors and, in particular, optical sensors so that the physical parameters and/or the seat position can be detected reliably. The first and/or second sensor units can for this purpose comprise, in particular, a multi-focus optical system or can detect wavelengths in the infrared range, with the result that reliable detection is ensured even in poor visibility conditions.

According to one preferred and/or alternative embodiment of the invention, the device for adjusting the seat position has means for communicating with a driver assistance system which is present, such as, in particular, the adaptive cruise controller (ACC). In a hazardous situation which is detected by the driver assistance system, the seat position can therefore be adjusted automatically into a safe seat position, as a result of which a risk of injury to the vehicle occupant is reduced.

A sensor which is present and, in particular, optical of a driver assistance system is preferably used as a first sensor unit of the device for adjusting the seat position.

According to one preferred and/or alternative embodiment of the invention, adaptive materials are integrated in the vehicle seat. The integrated adaptive materials comprise, in particular, electrorheological and/or magnetorheological fluids and/or an electrorheological and/or magnetorheological polymers. Mechanical properties of the vehicle seat can be changed in a reversible fashion by means of an electrical or magnetic field. In this context, the mechanical properties of the adaptive material can be changed by switching the electrical or magnetic field on and off, in such a way that switching over can take place between a first state, in which the seat position of the vehicle seat can be changed, and a second state, in which the seat position of the vehicle seat is fixed. The adaptive materials which are integrated in the vehicle seat permit particularly flexible adaptation of the seat position, which can be secured comfortably by means of the switching on and off of the electrical or magnetic field.

The control unit of the device for adjusting the seat position comprises at least one operator control element which permits the automatic adjustment of the seat position to be activated and deactivated. This operator control element serves, in particular, as an emergency off switch in order to prevent undesired automatic adaptation of the seat position. In this context, the operator control element can be arranged on the inside of the vehicle or can be integrated into a corresponding operator control interface of the portable communication means.

In this context, the control unit of the device for adjusting the seat position is preferably integrated into the respective vehicle seat, with the result that one structural unit is formed which can be mounted in a vehicle in a particularly easy way.

In one alternative embodiment variant, a conventional seat control device is arranged in the vehicle seat and is coupled to a control unit, arranged in the vehicle, for adjusting the seat position.

In the method for the automatic or automated adjustment of a seat position for a vehicle seat by means of a device, according to the invention a potential vehicle driver or vehicle occupant outside the vehicle is detected, in particular optically, by means of a first sensor unit, and physical parameters of the vehicle driver or vehicle occupant are determined from the acquired data and fed to a control unit for controlling the at least one drive unit of the vehicle seat, or a manual input of at least one physical parameter of the vehicle driver or vehicle occupant is made, in response to which the seat position of the vehicle seat is automatically adjusted to the physical parameters of the vehicle occupant and preset, wherein the ultimate seat position of the vehicle is set automatically after the arrangement of the vehicle occupant in the vehicle and said setting is assisted by means of the data which is acquired by a second sensor unit. When necessary, the vehicle occupant can adjust the seat position quickly and comfortably to his requirements in an optimum way by performing operator control on the control unit. In particular, in the case of regular use of the vehicle by a plurality of persons, which occurs, for example, in the case of family vehicles or hired vehicles, this can bring about a considerable saving in time.

According to one preferred refinement of the invention, the ultimate seat position is set automatically and said setting is assisted by means of the data detected by the second sensor unit. In this context, in particular data of at least one sensor which is integrated in or on a seat covering and/or of what is referred to as a time-of-flight (TOF) camera is used, with the result that operator control errors are advantageously ruled out and optimum protection of the vehicle occupant is ensured.

In another preferred refinement of the invention, on the basis of the physiognomy of the vehicle occupant and the resulting sensor data, setting recommendations, adapted to the vehicle occupant, for the adjustment of the seat position and/or warnings in the event of an unadapted seat position are displayed on a display unit in a passenger compartment of a vehicle or on the mobile communication means, with the result that in this way manual adjustment of the seat position by the vehicle occupant is assisted and simplified.

In the case of a hazardous situation which is detected by the first sensor unit, the seat position of the vehicle seat is moved automatically into a predefined seat position which is adjusted to the hazardous situation, as a result of which the risk of injury to the vehicle occupant can be reduced.

The invention will be described in more detail below with reference to the appended schematic figures, of which:

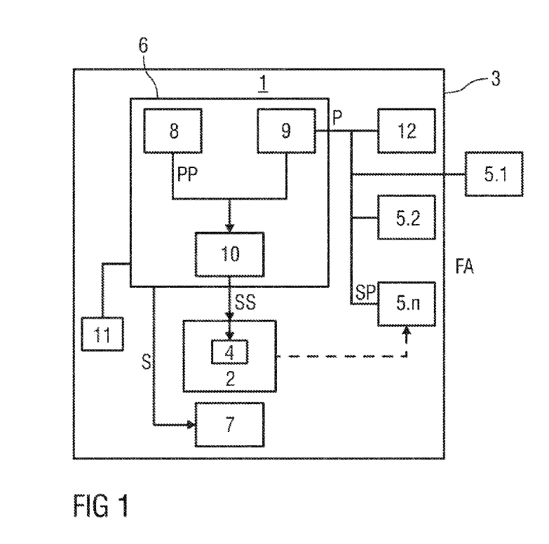

FIG. 1 is a schematic block illustration of individual components of a device according to the invention for adjusting the seat position in a first embodiment variant.

FIG. 1 is a schematic block illustration of individual components of a device 1 according to the invention for adjusting the seat position SP of a vehicle seat 2 which is arranged in a vehicle 3, in a first embodiment variant.

The device 1 for adapting the seat position SP comprises at least one vehicle seat 2 which is assigned at least one conventional, for example electrically or pneumatically driven, drive unit 4 for adjusting or setting the seat position SP of the vehicle seat, at least a first sensor unit 5.1 for determining physical parameters P of a vehicle occupant and, in particular, of a vehicle driver, and/or at least one second sensor unit 5.2 for determining the seat position SP of the vehicle seat 2, and at least one control unit 6 for the automatic or automated control of the drive unit 4.

Furthermore, the device 1 can have conventional input means 12 by means of which physical parameters P of a vehicle occupant and, in particular, of a vehicle driver can be input manually. Such an input means 12 can be embodied, for example, as a conventional touch-sensitive screen and/or a corresponding operator control key.

In one preferred embodiment, the device 1 comprises a conventional display unit 7 by means of which information can be displayed visually in a passenger compartment of the vehicle.

The sensor units 5.1 to 5.n preferably each comprise a plurality of sensors and are embodied, for example, as optical detection units such as, for example, laser scanners and/or cameras. These cameras may be conventional infrared cameras, CCD cameras, optical cameras and/or what are referred to as time-of-flight (TOF) cameras.

In one embodiment variant, the optical detection unit is embodied as a conventional two-dimensional camera system, for example as an infrared camera, CCD camera or optical camera. In order to detect depth information and/or distance information of a detected object, a combination of the two-dimensional camera system with a conventional distance sensor is necessary or what is referred to as a calibration object is used, i.e. an object in the detection range of the two-dimensional camera system with known dimensions, for example a vehicle component.

In a further embodiment variant, the detection unit is embodied as a conventional three-dimensional camera system, for example as a time-of-flight (TOF) camera, laser scanner and/or stereo camera. By means of such a three-dimensional camera system, depth information and/or distance information of a detected object can be measured directly.

Alternatively or additionally, the sensors of the sensor units 5.1 to 5.n are embodied as bionic sensors, pressure sensors, force sensors, infrared sensors, laser sensors and/or ultrasonic sensors.

In this context, the sensors of the sensor units 5.1 to 5.n can preferably be embodied as textile or polymeric capacitive or resistive sensors in a seat covering of the vehicle seat 2. By means of such a sensor, integrated into a seat covering, vital parameters of the vehicle occupant, for example a heart rate, a pulse and/or an electrocardiogram, can be detected.

A further sensor unit 5.n is preferably embodied as a conventional force sensor or pressure sensor and is arranged or integrated in or on a seat covering and/or in an upholstered seat element of the vehicle seat 2. By means of such a sensor, integrated in or on a seat covering and/or into an upholstered seat element, pressure distribution over a surface of the vehicle seat 2 can be detected.

A further sensor unit 5.1 to 5.n can be embodied as a conventional mobile communication means, for example as a portable telephone, in particular as what is referred to as a smart phone, as a portable computer unit or as a games console and can transmit user-specific data to a control unit 6 of the device 1 according to the invention.

As a result, a plurality of sensor units 5.1 to 5.n are arranged in and/or on the vehicle 3, wherein at least one sensor unit 5.1 to 5.n serves to determine physical parameters, in particular the physiognomy, of a vehicle occupant and, in particular, of a vehicle driver, and at least one further sensor unit 5.1 to 5.n permits the seat position of the vehicle seat 2 to be determined.

In one preferred embodiment of the invention, sensors which are already present in the vehicle 3 are used as sensor units 5.1 to 5.n of the device 1 for adjusting the seat position SP. The sensor units 5.1 to 5.n which are already present may be, for example, part of an existing driver assistance system or of an existing anti-theft protection system.

By means of at least one of the sensor units 5.1 to 5.n, an external region FA of the vehicle which surrounds the vehicle 3 can be at least partially detected. For this purpose, the sensors of the respective sensor unit 5.1 to 5.n are arranged on the outside of the vehicle or inside the vehicle, for example on an exterior rear view mirror of the vehicle, on an A pillar or B pillar of the vehicle 3, on a door trim of the vehicle, on an overhead console and/or on an inner roof lining of the vehicle 3.

The potential vehicle occupant, in particular the potential vehicle driver, who approaches the vehicle 3 can therefore already be detected in the external region FA of the vehicle by means of one of the sensor units 5.1 to 5.n. On the basis of the data which is detected by means of the respective sensor unit 5.1 to 5.n it is possible to determine and/or obtain physical parameters P, for example a body size, an upper body length and/or the length of extremities, in particular the length of legs and arms, of the vehicle occupant or vehicle driver.

According to one preferred embodiment of the invention, the respective sensor unit 5.1 to 5.n is arranged or oriented in such a way that the data for determining the physical parameters P can be detected when a vehicle door is opened.

Alternatively, the respective sensor unit 5.1 to 5.n can be arranged and/or oriented in such a way that an inner region of the vehicle can be detected at least in certain parts. The determination of the physical parameters P does not take place in this alternative exemplary embodiment until after the vehicle driver and/or the vehicle occupant have/has entered the vehicle 3.

In a further alternative embodiment, a vehicle occupant can input his physical parameters P manually, for example by means of the corresponding input means 12 in the vehicle or by means of the mobile communication means, and the adjustment of the seat position by the control unit 6 occurs in an automatic or automated fashion on the basis of this data.

The physical parameters P can be fed to the control unit 6 in order to control the drive unit 4, wherein the drive unit 4 receives at least one corresponding control signal SS from the control unit 6. The seat position SP of the vehicle seat 2 can be adjusted automatically by means of the drive unit 4 into a pre-set seat position which corresponds to the physical parameters P. For this purpose, in particular a longitudinal adjustment, a seat height, a seat inclination, a backrest inclination of the vehicle seat 2, a vertical adjustment and/or orientation of a headrest of the vehicle seat 2 can be changed.

In the case of the automatic pre-setting of the seat position SP to the physical parameters P, position parameters PP, which comprise, in particular, dimensions of a passenger compartment of the vehicle which is available for the adjustment of the seat position SP, have to be taken into account. These vehicle-specific position parameters PP are stored in a memory unit 8, preferably integrated into the control unit 6, and can be retrieved by the control unit 6 in order to adapt the seat position SP.

Alternatively or additionally, the position parameters PP can be detected by a sensor unit 5.1 to 5.n which is arranged on the inside of the vehicle. In this context, the position parameters PP include, in particular, a sitting place occupation of the vehicle 3. For this purpose, for example a corresponding sensor unit 5.1 to 5.n is integrated in the vehicle seat 2, by means of which sensor unit 5.1 to 5.n it is possible to detect whether a vehicle occupant is located on the vehicle seat 2.

A further sensor unit 5.1 to 5.n is mounted on the inside of the vehicle and detects at least partially the inner region of the vehicle. This sensor unit 5.1 to 5.n serves essentially to detect the, in particular, pre-set seat position SP of the vehicle seat 2, wherein position parameters PP which characterize the position of the vehicle seat 2 in the vehicle and relative to the vehicle occupant located on the vehicle seat 2 can be determined.

In this context, for example a distance between an inner roof lining of the vehicle 3 and the vehicle occupant's head, a distance between the vehicle occupant's knee and a foot well of the vehicle 3, a distance between the vehicle driver's foot and an accelerator pedal, a height of the headrest of the vehicle seat 2 compared to the vehicle occupant's head, a position of a hip of the vehicle occupant (referred to as an H point), an inclination angle of a torso of the vehicle occupant and/or an elbow angle of a vehicle occupant whose hand is resting on a steering wheel can be detected as position parameters PP.

In one preferred exemplary embodiment, an optical sensor of a sensor unit 5.1 to 5.n which is embodied as a camera serves additionally as a parking aid, for detecting road signs, as part of an authorization or identification system of the vehicle driver, for monitoring a seat position SP of the vehicle occupant, for monitoring a state of a vehicle occupant, in particular of a child, for making recordings during video telephone conferences and/or for recording videos, films and/or images.

The position parameters PP can be fed to the control unit 6 so that fine adjustment and ultimate automatic setting of the seat position SP are made possible. The detection of the position parameters PP prevents, in particular, a collision of the vehicle seat 2 with parts which are arranged on the inside of the vehicle during the adaptation of the seat position SP.

In order to adapt the seat position SP and, in particular, the positioning of the headrest of the vehicle seat 2, the drive unit 4 can have at least one electromechanical motor, a pneumatic adjustment device, a dielectric elastomer actuator and/or a bionic drive.

In one preferred exemplary embodiment of the invention, electrical or pneumatic drive units which are already present and which are integrated into the vehicle seat for seat adjustment are used to bring about the automatic adjustment of the seat position SP.

The control unit 6 comprises, in one preferred embodiment variant, an operator control interface 11 with a plurality of operator control elements or is coupled to such an operator control interface 11, which operator control elements permit the vehicle occupant and/or the vehicle device to perform manual control on the device 1 for adjusting the seat position SP. In this context, the operator control elements can be arranged in the inner region of the vehicle. Alternatively or additionally, operator control elements are provided which permit the device 1 for adjusting the seat position SP to be controlled from the external region FA of the vehicle. For example, it is possible to control the device 1 for adjusting the seat position SP by means of the mobile communication means.

In an alternative embodiment variant, a conventional seat control device, which is coupled to the control unit 6, arranged in the vehicle, for adjusting the seat position, is arranged in the vehicle seat 2.

In one exemplary embodiment of the invention, a remote control for a door unlocking and locking system of the vehicle 3 has an operator control element by means of which the automatic adjustment of the seat position SP can be activated and deactivated.

Furthermore, the vehicle seat 2 can have, for example, operator control elements which are arranged on the inside of the vehicle and which permit, for example, direct manual adjustment of the seat position SP. Alternatively or additionally, operator control elements for controlling the drive unit 4 are provided.

In one preferred exemplary embodiment of the invention, an operator control interface 11 of the control unit 6 is embodied as a plurality of force sensors or pressure sensors which are integrated in the vehicle seat 2 and which are embodied, in particular, as capacitive sensors. By means of these force sensors or pressure sensors it is possible to detect weight displacement of the vehicle occupant located on the vehicle seat 2. This detected weight displacement permits fine setting for the ultimate setting of the seat position SP. For this purpose, the drive unit 4 can be actuated by means of corresponding control signals SS.

In this exemplary embodiment, the conventional operator control elements for controlling the seat position SP can be replaced by the force sensors or pressure sensors which are integrated in the vehicle seat 2. The force sensors or pressure sensors function as a haptic operator control interface 11 at which the vehicle occupant applies pressure to the vehicle seat for the ultimate setting of the seat position SP in that the vehicle occupant displaces his body in the direction of the desired adjustment of the seat position.

The control unit 6 of the device 1 for adjusting the seat position SP comprises at least one operator control element or is coupled to such an operator control element which permits the automatic adjustment of the seat position SP to be activated and deactivated. This operator control element serves, in particular, as an emergency off switch in order to prevent undesired automatic adjustment of the seat position SP. In this context, the operator control element can be arranged on the inside of the vehicle or can be integrated into a corresponding operator control interface 11 of the portable communication means.

In order to obtain a control signal SS for setting a seat position SP which is optimized in a vehicle-occupant-specific fashion, the control unit 6 comprises different modules 9, 10, wherein a first module 9 permits detection of the entire physiognomy of the vehicle occupant from sensor data of all the sensor units 5.1 to 5.n.

The second module 10 is embodied as a conventional calculation or determining module and determines an optimized seat position SP on the basis of the data of the memory unit 8 and of the first module 9 and generates corresponding control signals SS for the drive unit 4 and/or a signal S for actuating the display unit 7.

In one preferred exemplary embodiment of the invention, the vehicle seat has integrated force sensors or pressure sensors and/or textile or polymeric capacitive or resistive sensors in or on a seat covering. By means of these sensors, a pressure distribution over a surface of the vehicle seat 2 and/or vital parameters of the vehicle occupant can be detected and fed to the control unit 6. These detected parameters permit fine setting for the ultimate setting of the seat position SP. For this purpose, the drive unit 4 can be actuated by means of corresponding control signals SS or corresponding setting recommendations can be displayed on the display unit 7.

In a first embodiment variant of the invention, on the basis of the physiognomy of the vehicle occupant and the resulting sensor data, setting recommendations, adapted to the vehicle occupant, for adjusting the seat position SP and/or warnings in the event of an unadjusted seat position SP are displayed on the display unit 7 in the passenger compartment of the vehicle, with the result that in this way manual adjustment of the seat position SP by the vehicle occupant is automated, assisted and simplified.

According to one preferred refinement of the invention, the setting of the ultimate optimized seat position SP takes place automatically and is assisted by means of the data detected by the sensor units 5.1 to 5.n. In this context, in particular data of at least one sensor which is integrated in a seat covering and/or of what is referred to as a time-of-flight (TOF) camera is used, with the result that operator control errors are advantageously excluded and optimum protection of the vehicle occupant is ensured by an optimized seat position SP.

For example, an ideal or optimized pressure distribution of the vehicle occupant arranged on the vehicle seat 2 is stored in the control unit 6, said ideal or optimized pressure distribution being compared inside the control unit 6 with the pressure distribution which actually occurs and is detected by means of one of the sensor units 5.1 to 5.n, wherein subsequently control signals SS and/or signals S which are adapted to the vehicle occupant are generated for setting and/or displaying an optimized seat position SP.

The seat position SP can be here a particularly comfortable or a particularly safe seat position and can be adapted in this way to traffic situations which occur and are detected.

Furthermore, the seat position SP can be optimized on the basis of the vital parameters of the vehicle occupant and set, with the result that, for example, premature fatigue of the vehicle driver can be counteracted.

In a method for the automatic or automated adjustment of a seat position SP, a potential vehicle driver or vehicle occupant is already detected, in particular, optically outside the vehicle 3 by means of a first sensor unit 5.1. On the basis of the detected data, at least one physical parameter P of the vehicle driver or vehicle occupant is determined and is transmitted to the control unit for controlling the drive unit 4 of the vehicle seat 2 or a manual input of at least one physical parameter P of the vehicle driver or vehicle occupant takes place, in response to which the seat position SP of the vehicle seat is adjusted to the physical parameters and/or setting recommendations, adapted to the vehicle occupant, for adjusting the seat position SP and/or warnings in the case of an unadjusted seat position SP are displayed by means of the display unit 7. In this context, pre-setting of the seat position SP can be performed and/or an ultimate seat position SP can be set. The vehicle occupant can, when necessary, adjust the seat position SP quickly and comfortably to his requirements in an optimum way by performing operator control on the operator control interface 11 of the control unit 6. In particular, in the case of regular use of the vehicle 3 by a plurality of persons, which occurs, for example, in the case of family vehicles or hired vehicles, this can bring about a considerable saving in time.

### LIST OF REFERENCE SYMBOLS

1 Device

2 Vehicle seat

3 Vehicle

4 Drive unit

5.1 to 5.n Sensor unit

6 Control unit

7 Display unit

8 Memory unit

9 First module

10 Second module

11 Operator control interface

12 Input means

SP Seat position

FA External region of the vehicle

P Physical parameters

SS Control signal

PP Position parameters

S Signal

1. A device for adjusting a seat position for a vehicle seat, comprising:
at least one drive unit for adjusting the seat position of the vehicle seat;
at least a first sensor unit for determining physical parameters of a potential vehicle occupant located outside the vehicle and/or at least one input device and/or at least one second sensor unit for determining the seat position of the vehicle seat; and
at least one control unit.

2. The device as claimed in claim 1, wherein one of the sensor units is embodied as a bionic sensor, pressure sensor, force sensor, infrared sensor, laser sensor and/or ultrasonic sensor, and/or in that one of the sensor units is embodied as an optical detection unit.

3. The device as claimed in claim 1, wherein one of the sensor units is embodied as a textile or polymeric capacitive or resistive sensor in or on a seat covering of the vehicle seat, and/or in that one of the sensor units is embodied as a force sensor or pressure sensor and is arranged or integrated in or on a seat covering and/or in an upholstered seat element of the vehicle seat.

4. The device as claimed in claim 2, wherein the optical detection unit is embodied as a two-dimensional camera system or as a three-dimensional camera system.

5. The device as claimed in claim 1, wherein one of the sensor units is embodied as a mobile communication device.

6. The device as claimed in claim 1, wherein the control unit is integrated into the vehicle seat, with the result that one structural unit composed of the vehicle seat and the control unit is formed.

7. The device as claimed in claim 1, wherein the control unit comprises at least one operator control element or an operator control interface, both of which permit the automatic adjustment of the seat position to be activated and deactivated.

8. A method for adapting a seat position for a vehicle seat by a device as claimed in claim 1, wherein a potential vehicle driver or vehicle occupant outside the vehicle is detected by a first sensor unit, and at least one physical parameter of the vehicle driver or vehicle occupant is determined from the acquired data and fed to a control unit for controlling the at least one drive unit of the vehicle seat, or in that a manual input of at least one physical parameter of the vehicle driver or vehicle occupant is made, in response to which the seat position of the vehicle seat is automatically adapted to the physical parameters of the vehicle occupant and preset, wherein the ultimate seat position of the vehicle is set automatically after the arrangement of the vehicle occupant in the vehicle and said setting is assisted by the data which is acquired by a second sensor unit.

9. The method as claimed in claim 8, wherein, on the basis of the physiognomy of the vehicle occupant and the resulting sensor data of the sensor units, setting recommendations, adapted to the vehicle occupant, for the manual adjustment of the seat position and/or warnings in the event of an unadjusted scat position are displayed on a display unit.

10. The method as claimed in claim 8, wherein in the case of a hazardous situation which is detected by the first sensor unit, the seat position of the vehicle seat is moved automatically into a predefined seat position which is adjusted to the hazardous situation.
